(19) United States
(12) Patent Application Publication
(10) Pub. No.: US 2018/0114529 A1
(43) Pub. Date: Apr. 26, 2018

(54) Cooling And/Or Freezing Device

(71) Applicant: LIEBHERR-HAUSGERATE OCHSENHAUSEN GMBH, Ochsenhausen (DE)

(72) Inventor: Herbert Gerner, Erlenmoos (DE)

(73) Assignee: LIEBHERR-HAUSGERATE OCHSENHAUSEN GMBH, Ochsenhausen (DE)

(21) Appl. No.: 15/567,613

(22) PCT Filed: Jul. 13, 2016
(86) PCT No.: PCT/EP2016/001210

§ 371 Date: Oct. 19, 2017

(30) Foreign Application Priority Data
Jul. 14, 2015 (DE) 10 2015 009 157.3

(51) Int. Cl. G10L 15/22; F25D 29/00; G10L 15/08

(52) U.S. Cl. CPC G10L 15/22; F25D 29/00; G10L 2015/088; F25D 2400/36; G10L 2015/223; G10L 15/08

(57) ABSTRACT

The present invention relates to a refrigerator unit and/or a freezer unit that has at least one voice control that comprises the following components: at least one detection device for speech recognition and at least one executing device that is configured to carry out at least one action of the refrigerator unit and/or freezer unit on the basis of speech recognized by the detection device.

The present invention relates to a refrigerator unit and/or a freezer unit

Refrigerator units and/or freezer units known from the prior art have a user interface by means of which the user can read off information or can enter inputs, e.g. the desired temperature in the refrigerated inner space. This user interface typically has buttons or a touch screen monitor by whose touch corresponding signals or commands are output that are then implemented by the unit.

It is the underlying object of the present invention to further develop a refrigerator unit and/or a freezer unit such that its operation is simplified with respect to known units.

This object is achieved by a refrigerator unit and/or a freezer unit having the features of claim 1.

Provision is accordingly made that the unit has at least one voice control that comprises the following components:
at least one detection device for the recognition of user speech;
at least one executing device that is configured to carry out at least one action of the refrigerator unit and/or freezer unit on the basis of speech perceived by the detection device.

It is thus the underlying object of the present invention to provide a refrigerator unit and/or a freezer unit with at least one voice control. This means that the refrigerator unit or freezer unit is able to recognize human language and to initiate an action of the unit based thereon.

The unit preferably has at least one processor that is connected to the detection device and that is configured to process recognized speech to form at least one signal.

Alternatively or additionally, a or the processor can be provided/configured that is connected to the executing device and that transmits or provides a signal to it that causes the executing device to take a specific action.

In a preferred device, the processor prepares at least one signal on the basis of the spoken information that is forwarded to the executing device or provided to it in another manner so that it carries out or initiates a specific action.

The processor can be an element of the unit or can also be designed as an external device to which the spoken information is sent by a communication (e.g. via radio, Internet) and that, in response thereto, sends a signal back to the unit that then causes the executing device to take a specific action.

If the processor is designed as an external device, provision can be made that the voice control or another component has one or more communication interfaces to the processor.

The feedback or the response of the unit that is carried out by the executing device can, for example, comprise the actual execution of the command, i.e. of speech, or also the optical or acoustic feedback.

It is, for example, conceivable that the user speaks the command “OK”, which activates the voice recognition system.

It is furthermore conceivable that the user defines a specific desired value for a compartment by voice in that he speaks the temperature, e.g. “5° C.”, or in that he defines a particular cooling mode in that he speaks a corresponding keyword, e.g. “Superfrost on” or “Superfrost off”, etc.

This spoken information are perceived by the detection device and forwarded to the processor that thereupon initiates or carries out a specific measure via the executing device such as the switching on of the compressor until the desired temperature value is reached, etc.

The feedback of information is also conceivable and covered by the invention. The user can thus, for example, query the actual temperature in the cooled compartment, whereupon it is displayed to him or is spoken out loud by means of a loudspeaker.

Provision is made in a further embodiment of the invention that the executing device is configured such that at least one component of the unit is switched on or off or its operating mode is changed on the basis of the signal. It can, for example, here be the compressor of the refrigerant circuit of the unit or an actuator that opens or closes the door or another closure element. The user can thus effect an opening of the door by the command “Open door” without having to have his hands free to do so.

It is also conceivable to implement a “help function” that can e.g. be activated by the key work “Help”. The user can then formulate a question and receives a feedback, e.g. by voice over a loudspeaker. Said feedback can then propose the possible further steps analog to a menu.

Instead of or in addition to an acoustic output by the unit, a visual perceivable output is also conceivable and covered by the invention.

Provision is made in a further embodiment of the invention that the executing device is configured such that at least piece of information perceivable for a user of the unit is output on the basis of the signal.

In this case, a dialog can be generated between the user and the unit. Unlike a purely command control, the user enters into a question-and-answer dialog or into another dialog with the unit, i.e. he receives perceivable feedback of the unit.

As stated above, the executing device can be configured such that the information output by it is output in a visually or acoustically perceivable form.

The voice control can be used to cause the unit to take specific measures such as to effect a particularly powerful cooling or also to receive suggestions. It is, for example, conceivable that the user indicates that he wants to freeze or refrigerate a specific quantity of a specific food.

This information is processed by the processor and is converted into a signal. The executing device receives this signal and then outputs a proposal such as that the product in question should be stored after a timely activation of a particularly intense refrigeration. It would be conceivable in this connection that the unit asks for the time at which the storing should take place and the unit then initiates the corresponding refrigeration in good time.

The voice control can have at least one memory in which information is stored which the processor can access, such as food-related information.

The voice control can also be used to obtain food information.

The dialog with the unit can thus e.g. be started by means of the voice control such that the user asks how he has to store a specific food.

Key words such as “Best before date” and/or help functions can also be used as part of the receiving of food information.

A preferred embodiment of the invention generally comprises one or more help functions being able to be accessed in each dialog level.

Conceivable feedback information such as feedback information output by the executing device at the user interface, e.g. at a display, can e.g. relate to:
displaying the food and/or the associated storage data;
voice output with the desired food information;
additional information on the unit settings such as the storage location; and
queries whether the unit or the proposed compartment should be set suitably for the respective food with respect to temperature and/or humidity.

The voice control can be integrated in or form a user interface of the unit.

It is thus possible, for example, that the voice control is partly or completely integrated in a user interface and/or in the unit control. The user interface can, for example, be located in or behind the door at the body of the unit or behind or in another closure element of the unit.

It is also conceivable that the voice control completely or partly replaces or forms the user interface of the unit. In this case, there is preferably no further user interface, e.g. no keypad, except for the voice control.

All the commands and the information are exchanged or output via the voice control in this case.

It is furthermore conceivable that the unit has at least one unit control that controls or regulates the operation of the unit overall and that the voice control is designed as a control separate from the unit control.

The voice control can be an autonomous system, i.e. a system independent of the unit control. Only a power supply of the voice control is necessary. This can be done autonomously or the power is drawn from a source such as from the unit control.

It is also conceivable that the unit has at least one unit control that controls or regulates the operation of the unit overall or substantially and that the voice control is connected to the unit control or forms an element of the unit control. The voice control can thus also be partly or entirely integrated in the unit control.

The detection device of the voice control can be designed as a microphone. It can be integrated in the refrigerator unit and/or freezer unit. The microphone can be arranged at any desired suitable point within the cooled inner space or also outside the unit.

This executing device can be designed as a loudspeaker. It can be integrated in the refrigerator unit and/or freezer unit. The loudspeaker can be arranged at any desired suitable point within the cooled inner space or also outside the unit.

It is pointed out at this point that a detection device and/or an executing device that is/are not arranged directly at the unit, but is/are rather spaced apart from it is/are understood as the executing device of “the unit”. The connection between the detection device and the executing device can, for example, take place in a cabled or cable-free manner, e.g. by Bluetooth.

Depending on the desired embodiment, the executing device can also be designed as a visual display unit. A loudspeaker is thus not absolutely necessary.

Examples for executing devices are visual or acoustic units such as buzzers or loudspeakers.

As stated above, the voice control can be designed as an autonomous system. This means that the voice control is not connected to the (remaining) unit control via a communications interface.

The voltage supply of the voice control can take place separately or via the unit control. The latter makes it possible to switch off the total module, i.e. the total voice control, for energy consumption reasons when the voice control is not required.

Provision is made in an embodiment that the voice control is always ready for operation or that this is not the case and that activation means are provided that put the voice control into operation.

These activation means can comprise detection means for detecting speech or can at least comprise a sensor, wherein the sensor is, for example, configured as a proximity sensor for detecting the opening of the closure element.

A “wake-up” function of the voice control is thus e.g. conceivable via a signal from the unit control to consume as little energy as possible in normal operation. In this case, the voice control is not autonomous of the unit control, but is activated by it.

If it is an autonomous voice control, the function of the food information or other functions for the unit operation/operating instructions would be conceivable, i.e. the total functional extent that does not require any status information of the unit and also does not result in any control of the unit.

It is alternatively conceivable to connect the voice control to the unit control via an interface or to integrate it fully with the unit control to implement a data exchange between the voice control and the unit control. All the unit information can hereby be integrated in the voice dialog with the user. A further advantage comprises the unit functions being able to be influenced via the voice dialog or via the voice signal of the user.

As stated above, the voice control is preferably configured such that it is not constantly ready for operation and thus includes all background noises in the analysis or in the speech interpretation. The voice control is thus preferably in a standby mode and is only started in a targeted manner as required.

This activation can take place by:
one or very few keywords, i.e. the voice control is constantly ready for operation so that the detected words are analyzed, but only becomes active when a keyword is detected; the use of a very distinctive term can, for example, be necessary to start a voice dialog or to start the voice control;
a proximity switch that detects the presence or the approach of a person. It could be a passive infrared sensor or a radar sensor;
other motion detection means such as a camera; and
a door opening by the user. The voice control is thereby activated. An inexpensive overall concept could thereby in particular be implemented using a configuration with a user interface behind the door.

An expansion of the voice dialog or of the recognized terms of the user can be implemented during the product service life, for example by a software update.

Provision is made in a preferred further development of the invention that the voice control is configured such that it is connected to the internet permanently or at times.

If queries occur in the voice dialog, e.g. about the storage of specific foods, that are not stored in the voice dialog or in the memory of the voice control, the voice control can make use of the internet.

This could take place, for example, such that the speech data (raw data or compressed data) are transmitted to a central server that then returns the corresponding speech output (raw data or compressed data) to the voice control and the output then takes place there via the loudspeaker or via a display.

The feedback from the server can take place in real time here, but it is not absolutely necessary. In parallel with the transmission of the speech data, an output to the user could take place in which the user is informed of the query so that a certain bridging time is created.

Further details and advantages of the invention will be explained in more detail with reference to an embodiment described in the following.

The embodiment relates to a refrigerator unit and/or a freezer unit having a microphone and having an executing device that are both connected to a unit-internal processor.

The microphone receives voice signals of a user such as the signal “Open door”. This signal is processed by the processor that thereupon transmits a signal to an actuator of the unit, whereby the latter is activated and the door of the unit opens.

In a further embodiment, the voice control has a loudspeaker as the executing device by means of which questions of the user can be answered.

If the user, for example, asks the question as to at which temperature milk can be stored the longest, this question is processed by the processor and a signal representing the ideal temperature is output to the loudspeaker that reproduces the temperature value in a manner audible to and understandable for the user.

It is then conceivable that the unit asks whether a compartment should be cooled to this temperature. The user can then answer this question, with the processor, in the case of a yes, controlling the compressor of the refrigerant circuit and/or valves for conducting cold air such that the desired temperature is reached in the respective zone.

In addition, where this zone or this compartment is located can be displayed to the user on a display.

The voice control can have at least one memory in which e.g. food-specific and/or unit-specific information is stored.

If a question of the a user cannot be answered by this information, the unit determines this and transmits a corresponding query to an external server.

This server determines the correct answer that is then output to the user.

This output can take place visually or also acoustically.

The connection of the unit to the internet (optionally via a wireless LAN) can be permanent or can only be set up in the event that the required data are not stored in the memory of the unit itself.

1. A refrigerator unit and/or a freezer unit, characterized in that the unit comprises at least one voice control that comprises the following components: at least one detection device for speech recognition and at least one executing device that is configured to carry out at least one action of the refrigerator unit and/or freezer unit on the basis of speech recognized by the detection device.

2. A refrigerator unit and/or a freezer unit in accordance with claim 1, characterized in that the voice control comprises at least one processor or at least one interface to a processor that is configured such that it generates at least one signal on the basis of speech recognized by the detection device.

3. A refrigerator unit and/or a freezer unit in accordance with claim 1 or claim 2, characterized in that the voice control comprises at least one processor or comprises at least one interface to a processor that is configured such that it generates a signal by which the executing device is controlled.

4. A refrigerator unit and/or a freezer unit in accordance with claim 1, characterized in that the executing device is configured such that at least one component of the unit is switched on or off or its mode of operation is changed on the basis of the signal.

5. A refrigerator unit and/or a freezer unit in accordance with claim 1, characterized in that the executing device is configured such that at least one piece of information perceptible to a user of the unit is output on the basis of the signal.

6. A refrigerator unit and/or a freezer unit in accordance with claim 1, characterized in that the voice control is integrated into or forms a user interface of the unit.

7. A refrigerator unit and/or a freezer unit in accordance with claim 1, characterized in that the unit has at least one unit control that controls or regulates the operation of the unit; and in that the voice control is configured as a control separate from the unit control.

8. A refrigerator unit and/or a freezer unit in accordance with claim 1, characterized in that the unit has at least one unit control that controls or regulates the operation of the unit, and in that the voice control is connected to the unit control or forms a part of the unit control.

9. A refrigerator unit and/or a freezer unit in accordance with claim 1, characterized in that activation means are provided that are configured such that they put the voice control into operation.

10. A refrigerator unit and/or a freezer unit in accordance with claim 1, characterized in that the voice control is configured such that it is connected to the interne permanently or at times.
